(19) United States
(12) Patent Application Publication
(10) Pub. No.: US 2009/0113006 A1
(43) Pub. Date: Apr. 30, 2009

(54) Method and apparatus for mutual exchange of sensitive personal information between users of an introductory meeting website

(76) Inventor: Kal McWana, Mitcham (GB)

Correspondence Address: Russ Weinzimmer, 614 Nashua Street, Suite 53, Milford, NH, 03055, US

(21) Appl. No.: 11/981,894

(22) Filed: Oct. 31, 2007

(51) Int. Cl. G06F 15/16; G06F 21/22; G06F 3/048

(52) U.S. Cl. 709/206; 726/2; 715/846

(57) ABSTRACT

Methods for simultaneous exchange of sensitive personal information between two unrelated parties are disclosed, such as between two users of an online networking website or introductory meeting website, the information being mutually accessible to both users upon exchange. The invention allows for exchange of sensitive personal information between two parties only if both parties indicate a willingness to participate in such exchange. A host data server facilitates information exchanges, otherwise protecting the sensitive personal information. This invention is particularly useful for online dating websites, where the sensitive personal information may include personal photographs or phone numbers. In preferred embodiments, the exchange of sensitive personal information occurs simultaneously, and the sensitive personal information can be simultaneously presented to the two parties.

### FIELD OF THE INVENTION

The invention relates to introductory meeting websites, and particularly to communication between users of such websites.

### BACKGROUND OF THE INVENTION

Internet websites that help people to meet other people with common interests, common goals, etc are now well-known and popular. Such websites include dating websites, friendship website, roommate matching websites, hobby and mutual interest websites, seller-to-buyer sales websites, mutual interest and hobby websites, landlord-tenant matching websites, and business networking websites, for example.

Users of such websites create “profiles” that include much personal information, such as interests, personal characteristics, and biographical information. When two users of an introductory meeting website have reviewed each other's profile, they may develop a mutual interest in each other. At such time, they may wish to learn more about each other.

Two users presently learn more about each other than what is presented in their profiles by chatting via an Instant Messenger service, such as Yahoo IM, AIM, or the like. Or, they may use a built-in message service provided within the dating website.

As the relationship between the two people using the site progresses, they may want to leave the confines of the website, and exchange emails, or talk on the phone. Also, as the relationship progresses, each may be interested in seeing a personal photograph of the other, in the case where the two people have not posted a photograph for public viewing, such as when privacy and confidentiality are important.

Another item of sensitive personal information is personal contact information, such as the home phone number, personal cell phone number, and/or the personal email address of a person. People are typically reluctant to disclose such sensitive and/or personal information to people that they have recently met because of fears or concerns that such information may be abused by the other.

Yet another item of sensitive information is a reaction to an in-person encounter, such as a first date. People are often very reluctant to be the first to reveal their reaction to such an encounter, since it is highly likely that the response of the other person will be strongly affected by what they reveal, and they will never know what the other person would have said if they had offered their reaction first.

One other concern is that if a first person reveals personal or sensitive information, such as a phone number or a photograph, the other person will NOT reciprocate. Even if there is an explicit agreement made between the two persons to exchange the personal information, such an arrangement may fail due to the very transfer of the personal information itself.

For example, if the personal information to be exchanged includes personal photographs, then the party that first receives a photograph of the other may decide not to reciprocate. This can happen if the photograph reveals that the other person is not sufficiently attractive to maintain the interest of the first person. Or, a first person may simply change his mind after receiving a private phone number of a second person, and that second person may have no way of contacting the first person due to a lack of any personal contact information.

Thus, any one user may be reluctant to send this information to another user, even upon receipt of the sensitive personal information of the other user. In the typical dating website, for example, one user is often faced with the undesirable prospect of sharing their sensitive personal information with another user, without receiving that same kind of information from the other user. Such a risk-laden situation may discourage any one user from sending sensitive personal information to another user, especially where the other user may be a complete stranger.

### SUMMARY OF THE INVENTION

The invention overcomes the problems of known introductory meeting websites by ensuring simultaneous exchange or access to sensitive personal information upon mutual assent to such an exchange. Thus, unless both parties agree, no sensitive personal information, such as a photographs and home phone numbers, is exchanged or made available from a secure location on a web server of the website.

One general aspect of the invention is a method for exchanging sensitive personal information between a first user and a second user of an online introductory meeting website, each user having a publicly viewable profile stored on the website. The method includes the first user accessing the publicly viewable profile of the second user, and the second user accessing the publically viewable profile of the first user. The method then includes the first user sending a first message to the second user requesting sensitive personal information pertaining to the second user, in exchange for the first user providing to the second user personal information pertaining to the first user. The method then includes the second user sending a second message to the first user indicating a response to the first message, agreeing to provide the first user with sensitive personal information pertaining to the second user if the response is positive, and not agreeing to provide the sensitive personal information to the first user if the response is negative. Next, the method includes the first user and the second user both informing the website of their willingness to mutually share sensitive personal information if the response of the second user was positive, and the first user and the second user taking no action if the response was negative. Then, if both the first user and the second user have agreed to a mutual exchange of personal information, the method includes the first user and the second user providing their personal information to the website, if it has not already been provided to the website. Next, the method includes the website providing the sensitive personal information of the first user to the second user, and the website also providing the sensitive personal information of the second user to the first user, if information is received from both the first user and the second user indicating that each has agreed to a mutual exchange of sensitive personal information with the other, and no action being taken by the website if such information is not received from at least one of the first user and the second user.

In a preferred embodiment, the sensitive personal information is a photograph, or a reaction to a first date or other in-person encounter for example using a color scale such as green, red, amber, etc., a numerical scale such as 1 to 5, or some other rating means. In other preferred embodiments, the sensitive personal information is at least one member of the set of identifying contact details that includes: a telephone number, an email address, an instant messaging address, a mailing address, and other identifying contact details.

In a preferred embodiment, the first user sending a first message to the second user includes sending the first message within the online dating website. In another preferred embodiment, the first user sending a first message to the second user includes sending the first message via email. In a further preferred embodiment, the first message is sent by the first user clicking on an icon. In a still further preferred embodiment, clicking on the icon results in adding the profile to a sensitive personal information exchange list.

In some preferred embodiments, if the response is positive, the first user provides the second user with access to the sensitive personal information of the first user at the same time that the second user provides the first user with access to the sensitive personal information of the second user.

In yet other preferred embodiments, the sensitive personal information of the first user and the sensitive personal information of the second user are both stored on a server that hosts the website.

Another general aspect of the invention is a method for exchanging sensitive personal information between a first user and a second user of an online dating website, wherein the method includes each user storing a profile on a server that hosts the website, each profile including sensitive personal information; and providing the first user with access to the sensitive personal information of the second user, and providing the second user with access to the sensitive personal information of the first user, only if both the first user and the second user have informed the website of a willingness to mutually exchange sensitive personal information.

In a preferred embodiment, the sensitive personal information is a photograph or a reaction to a first date or other in-person encounter, for example using a color scale such as green, red, amber, etc., a numerical scale such as 1 to 5, or some other rating means. In other preferred embodiments, the sensitive personal information is at least one member of the set of identifying contact details that includes: a telephone number, an email address, an instant messaging address, a mailing address, and other identifying contact details.

In other preferred embodiments, the first user is provided with access to the sensitive personal information of the second user, and simultaneously the second user is provided with access to the sensitive personal information of the first user.

In still other preferred embodiments, sensitive personal information is stored on the server as part of a record in a data table. In a further preferred embodiment, the record in the data table also includes a data status field that encodes information regarding access properties of the record, and consequently of the personal information stored therein.

In some preferred embodiments, when both the first user and the second user have informed each other of a willingness to mutually exchange sensitive personal information, both the first user and the second user add each other to a sensitive personal information exchange list. In a further preferred embodiment, the sensitive personal information exchange list is checked by the server before allowing access to sensitive personal information. In an alternate further preferred embodiment, access to sensitive personal information can be blocked by either the first user or the second user removing the other from the sensitive personal information exchange list.

In other preferred embodiments, a user informs another user via an instant message system of a willingness to mutually exchange sensitive personal information.

Another general aspect of the invention provides a method for exchanging sensitive personal information between a first user and a second user of an online dating website, each user having a profile stored on the website, each profile including sensitive personal information, each user initially having access to each other's profile, but not each other's sensitive personal information Here, the method includes the first user gaining access to the sensitive personal information of the second user, and the second user gaining access to the sensitive personal information of the first user, only after both the first user and the second user have informed each other of a willingness to mutually grant access to sensitive personal information.

In preferred embodiments, the first and second users gain access to each other's sensitive personal information simultaneously.

In other preferred embodiments, when both the first user and the second user have informed each other of a willingness to mutually grant access to sensitive personal information, both the first user and the second user are allowed access to the sensitive personal information resident on the server that hosts the online dating web site.

In still other preferred embodiments, if either the first user or the second user indicates an unwillingness to grant access to sensitive personal information, such access is blocked.

In yet other preferred embodiments, the second user is informed of a willingness of the first user to mutually grant access to sensitive personal information via a server that hosts the online dating website.

In further preferred embodiments, the host server informs the first user and the second user of a willingness to mutually grant access to sensitive personal information by sending respective emails. In other preferred embodiments, the host server informs the first user and the second user of a willingness to mutually grant access to sensitive personal information by posting respective account messages. In still other preferred embodiments, the host server informs the first user and the second user of a willingness to mutually grant access to sensitive personal information by simultaneously posting respective account messages, and also simultaneously removing a block that prevents the first user from accessing the sensitive personal information of the second user, and prevents the second user from accessing the sensitive personal information of the first user.

In further preferred embodiments, the host server informs the first user and the second user of a willingness to mutually grant access to sensitive personal information by simultaneously posting respective account messages, and also by simultaneously sending via email the sensitive personal information of the second user to the first user, and sending via email the sensitive personal information of the first user to the second user.

In a preferred embodiment, the sensitive personal information is a photograph or a reaction to a first date or other in-person encounter, for example using a color scale such as green, red, amber, etc., a numerical scale such as 1 to 5, or some other rating means. In other preferred embodiments, the sensitive personal information is at least one member of the set of identifying contact details that includes: a telephone number, an email address, an instant messaging address, a mailing address, and other identifying contact details.

Another general aspect of the invention is a method for exchanging a personal photograph between a first user and a second user of an online dating website, each user having a profile stored on the website, each profile including a personal photograph. The method includes the first user accessing the profile of the second user, without being able to access the personal photograph of the second user, and the second user accessing the profile of the first user, without being able to access the personal photograph of the first user. Next, the method includes the first user sending a first message to the second user requesting access to the personal photograph of the second user, in exchange for granting permission for the second user to access the personal photograph of the first user. Then, the method includes the second user sending a second message to the first user indicating a response to the first message, agreeing to provide the first user with access to the personal photograph of the second user if the response is positive, and not agreeing to provide the first user access to the personal photograph of the second user if the response is negative. Next the method includes the first user and the second user both informing the website of their willingness to mutually share sensitive personal photographs if the response of the second user was positive, and the first user and the second user taking no action if the response was negative. And then, the method includes the website providing the personal photograph of the first user to the second user, and the website also providing the personal photograph of the second user to the first user, if information is received from both the first user and the second user indicating that each has agreed to a mutual exchange of personal photographs with the other, and no action being taken by the website if such information is not received from at least one of the first user and the second user.

In a preferred embodiment, the first message is sent by the first user by clicking on an icon, whereupon a message is sent to the second user indicating a photo exchange is desired, and whereupon the profile of the second user is placed on the photo swap list of the first user.

In another preferred embodiment, the second message is sent by the second user by clicking on an icon, whereupon a message is sent to the first user indicating a photo exchange is desired, and whereupon the profile of the first user is placed on the photo swap list of the second user.

In preferred embodiments, the first message is sent from the first user to the second user within the dating website. In other preferred embodiments, the second message is sent from the second user to the first user within the dating website.

In other preferred embodiments, the first message is sent by the first user by clicking on an icon, whereupon the profile of the second user is placed on the photo swap list of the first user, and wherein the second message is sent by the second user by clicking on an icon, wherein whereupon the profile of the first user is placed on the photo swap list of the second user; and then the personal photograph of the first user is made available to the second user while the personal photograph of the second user is made available to the first user.

In a further preferred embodiment, the personal photograph of the first user is made available to the second user by sending the personal photograph of the first user to the second user, while the personal photograph of the second user is made available to the first user by sending the personal photograph of the second user to the first user.

In an alternate preferred embodiment, the personal photograph of the first user is made available to the second user by removing a block preventing the second user from viewing the personal photograph of the first user, while the personal photograph of the second user is made available to the first user by removing a block preventing the first user from viewing the personal photograph of the second user.

### BRIEF DESCRIPTION OF THE DRAWINGS

FIG. 1 is a schematic diagram showing each user accessing only the portion of the other user's profile that is not deemed sensitive and personal, such sensitive personal information being protected by a data block controlled by the website host;

FIG. 2 is a schematic diagram showing a first user requesting of a second user mutual access or exchange of sensitive personal information;

FIG. 3 is a schematic diagram showing a second user responding to the request of the first user, either accepting or rejecting the offer of a mutual exchange of sensitive personal information;

FIG. 4 is a schematic diagram showing both the first and second users informing the website host of their decision to mutually share sensitive personal information according to the invention;

FIG. 5 is a schematic diagram showing that the website host has removed the data block, thereby enabling access by each user to the other user's sensitive personal information;

FIG. 6 is a schematic diagram showing one user informing the website host of the desire to no longer share sensitive personal information with the other user, resulting in re-establishing the data block;

FIG. 7 is a flow diagram showing steps of an interaction between a first user, a second user, and a website according to the invention;

FIG. 8 is an illustration of an icon of the invention having text that invites a first user to send an offer to a second user proposing a mutual exchange of sensitive personal information; and

FIG. 9 is a flow diagram showing steps of an alternate embodiment interaction between a first user, a second user, and a website according to the invention.

### DETAILED DESCRIPTION OF THE DRAWINGS

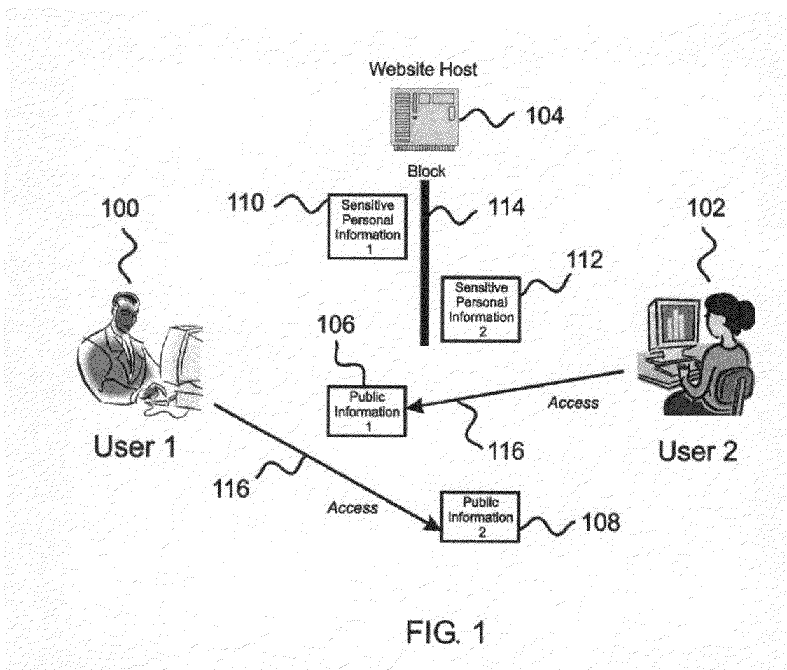

With reference to FIG. 1, two persons 100, 102, indicated as User 1 and User 2, respectively, have both stored information in the form of a “user profile” on an introductory meeting website controlled by a website host 104. Such introductory meeting websites include websites for finding partners for dating, marriage, room mates, friendship, pen pals, landlords and tenants, etc. Also, the invention is useful for facilitating business networking websites, websites that provide introductions to persons that share mutual interests and hobbies, and any other website that provides the service of introducing people who are initially unknown to each other. Accordingly, such people unknown to each other will be careful not to share personal or other sensitive information, such as a home phone number, a cell number, a private email address, or a personal photograph, until a certain level of trust and/or interest is established between the two persons.

A user profile stored by each individual on the website includes information that is not deemed sensitive or personal 106, 108, and is therefore classified as “public” information. Such public information of each profile is made generally available for viewing by anyone. Each profile can also include sensitive, personal information 110, 112 that is stored by the host 104 of the website, but is not generally available for viewing and/or access by unauthorized persons. According to the invention, such viewing or access is only available upon agreement between two users to mutually view each other's sensitive personal information. Until such agreement is reached, in the preferred embodiment of FIG. 1, the sensitive personal information is protected by a “data block” 114, such that access by any user other than the originating user is blocked 114. In some preferred embodiments, a user may elect to upload personal information to the website only when mutual agreement to share the information has been reached with another user of the website, and in some of these preferred embodiments the website stores the personal information only long enough to carry out the mutual exchange.

Through various browsing, searching, and messaging means provided by the website host, the two persons shown in FIG. 1 are brought into awareness of each other, and then are enabled to communicate with each other. Each user can also view 116 the generally accessible portion of the other user's profile 106, 108.

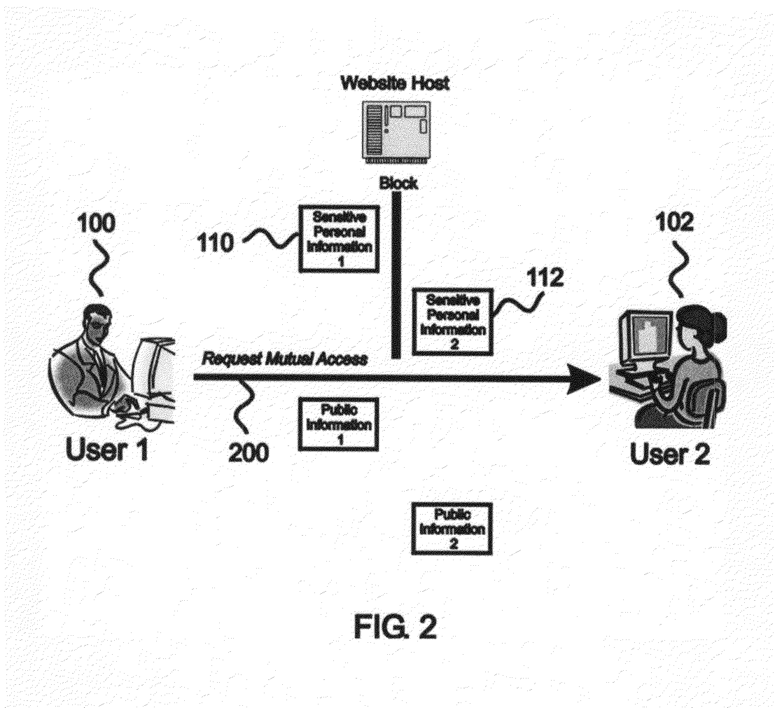

FIG. 2 shows one of the users, in this case User 1, sending a message 200 to the other user offering a mutual exchange of sensitive personal information. The message 200 may be anonymously transmitted through the website host, or the two users may have already exchanged sufficient information to allow them to directly contact each other, as shown in the figure, by email, instant message, text message, or other direct contact means.

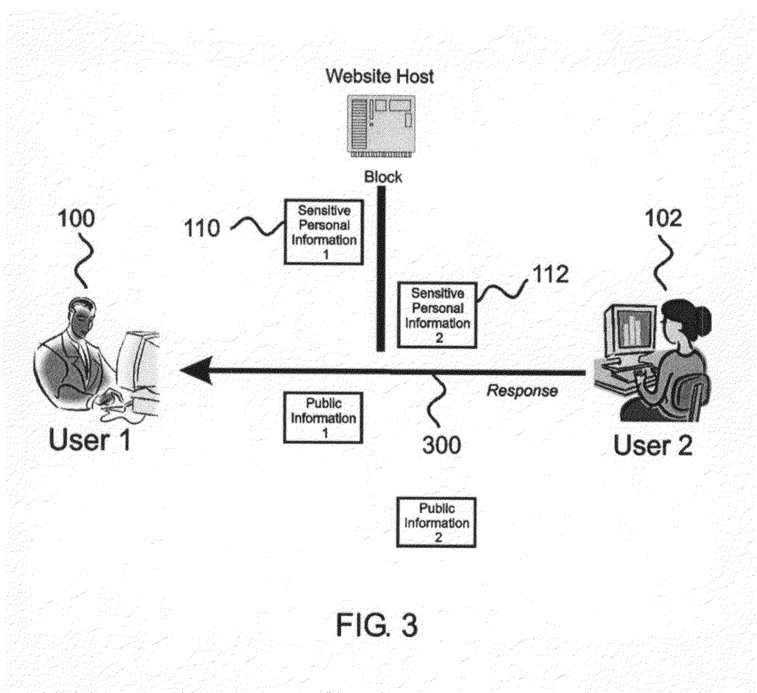

In FIG. 3, User 2 responds 300 to an offer of mutual exchange of personal private information received from User 1. The response 300 sent by User 2 may be directly and anonymously transmitted through the website host, or the two users may have already exchanged sufficient information to allow them to directly contact each other, as shown in the figure, by email, instant message, text message, or other direct contact means. Regardless of how it is transmitted, the response will be either positive or negative. If the response is negative, there is no mutual exchange of sensitive personal information. If the response is positive, according to the invention, there can now be a mutual exchange of sensitive personal information.

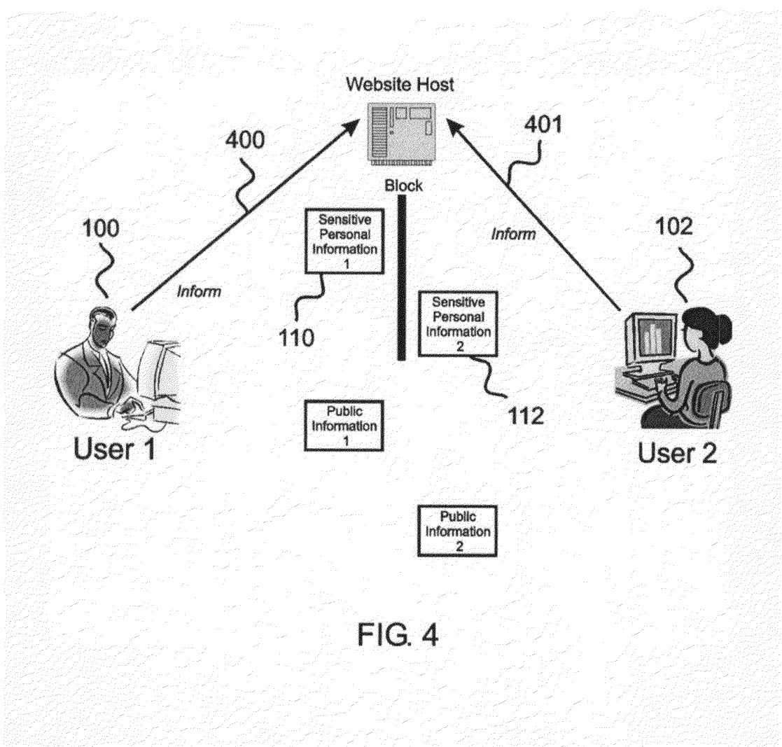

FIG. 4 illustrates what happens after User 1 has offered a mutual exchange of personal private information, and User 2 has responded positively. Both users inform the website host of their decision 400, 401. This may require the sending of a separate message by each user to the website host 104, or the host 104 may be informed automatically if the message from User 1 to User 2 offering the mutual exchange, and the response from User 2 to User 1 accepting the exchange, are both transmitted via the host computer 104.

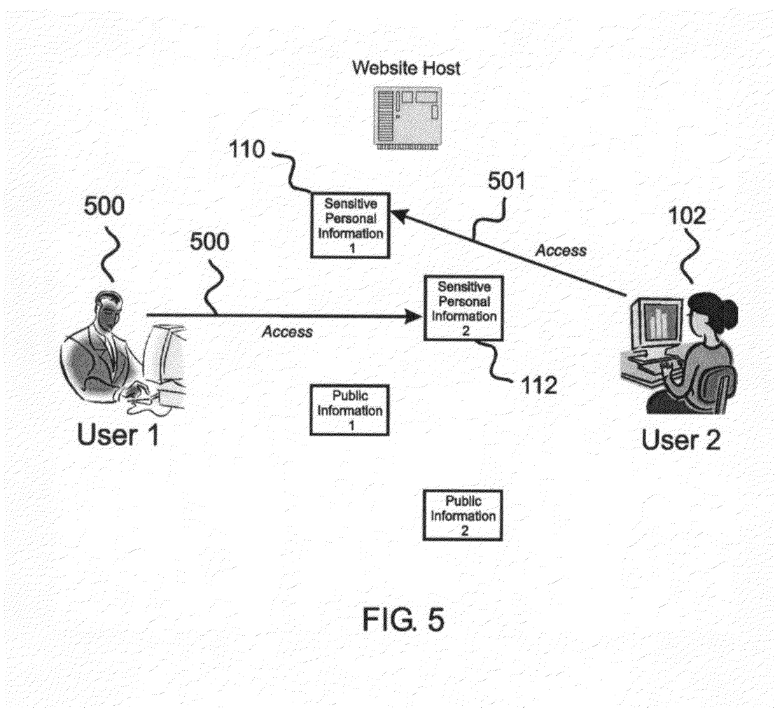

FIG. 5 shows that, once the website host has determined that both User 1 and User 2 have agreed to the information exchange, the website host provides access 501 to User 2 to the sensitive personal information 110 previously stored on the website by User 1, and also provides access 500 to User 1 to the sensitive personal information 112 previously stored on the website by User 2. This may be accomplished as shown in the figure simply by removing the block 114 that would normally prevent each of User 1 and User 2 from accessing each other's sensitive personal information 500 and 501, or it may be accomplished by transmitting the information to the users by email or some other transmission means. It may also be revealed simultaneously to both User 1 and User 2 via a special section of the website that requires both users to be actively logged in before the sensitive personal information from either user is provided, or by some other simultaneous transmission means. In some preferred embodiments, a user may elect not to store personal information on the website, while in other preferred embodiments the option of storing personal information on the website is not offered. In these preferred embodiments, an additional step is sometimes required of one or both users temporarily providing their personal information to the website for the purpose of carrying out the mutual exchange, after which the personal information is deleted from the website.

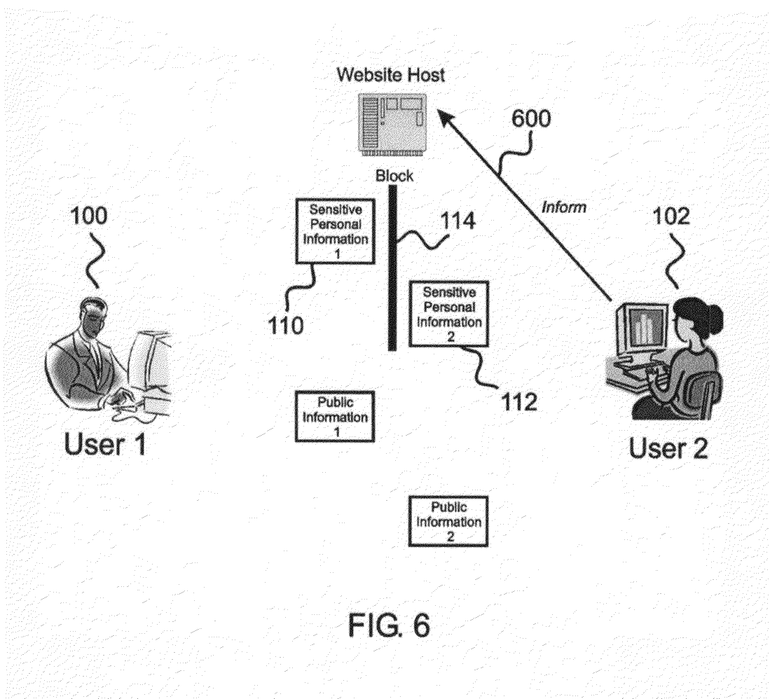

FIG. 6 illustrates an optional aspect of the invention in which at least one user, in this case User 1, informs 600 the website host of a desire to terminate the exchange of sensitive personal information with another user. Upon receipt of this information, the website host reestablishes the block 114 that prevents User 1 from accessing the sensitive personal information of User 2, and also prevents User 2 from accessing the sensitive personal information of User 1.

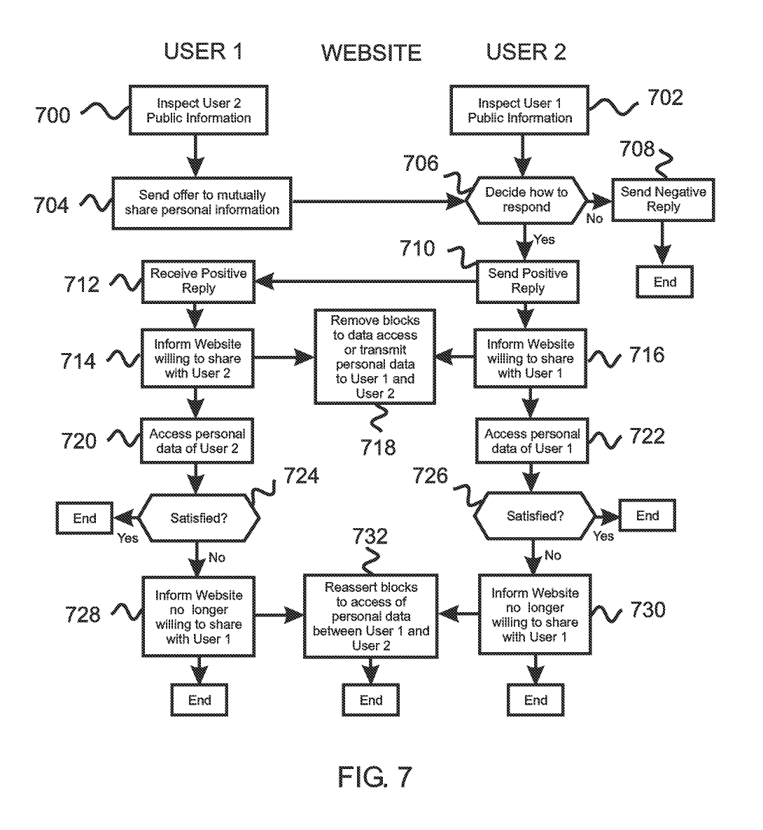

FIG. 7 illustrates a method of the invention in the form of a flow chart. User 1 and User 2 each read the generally accessible portion of the other user's profile 700 and 702. User 1 sends a message to User 2 offering a mutual exchange of sensitive, personal information 704. User 2 must then decide whether to respond positively or negatively 706. If a negative reply is sent by User 2 (708) the method terminates. If a positive reply is sent 710, it is then received by User 1 (712), and both users send messages to the website accordingly 714 and 716.

The website then provides to User 1 access to the sensitive personal information of User 2 and also provides to User 2 access to the sensitive personal information of User 1 (718). Depending on the embodiment of the method, the website accomplishes this by removing existing blocks to data access 718, such that User 1 and User 2 may each access the other's sensitive personal information through the website in the same manner as they formerly accessed other information about each other, by transmitting the information directly to each of the users, through email or some other messaging means, by allowing both User 1 and User 2 to access a special area of the website were the information is made available to both simultaneously, or by some other transmission means.

User 1 and User 2 proceed to access each other's sensitive personal information 720 and 722. If the sensitive personal information was distributed by email or some other direct messaging means, the method terminates at this point. However, in an embodiment whereby the formerly blocked sensitive personal information is made available to the users through removing data blocks on the website, the method continues with User 1 and User 2 each deciding whether or not to allow the sensitive personal information to remain available to the other user 724 and 726. If each of them decides to allow their sensitive personal information to remain available to the other, then the method terminates. However, if at least one of User 1 and User 2 decides not to allow the sensitive personal information to remain available 728 and 730, then upon receiving a message to this effect from at least one of User 1 and User 2, the website reasserts the data blocks that were in place before the method was initiated 732.

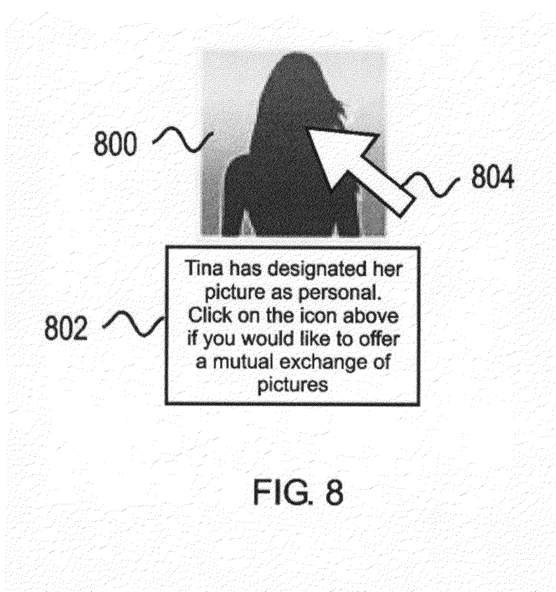

Referring to FIG. 8, transmittal of any or all of the messages of 704, 708, 710, 714, 716, 728, and 730 may be automated by providing an appropriate icon on the website for each message type that is to be automated. An illustrative example is presented in FIG. 8, where the sensitive personal information is a photograph of the user. In this example, a standard icon 800 appears on the website in a location where a user's photo would otherwise appear if the user did not consider the photo to be sensitive personal information. An accompanying text 802 informs the user viewing the profile that by clicking on the icon, a standard message may be sent to the user whos profile is being viewed that will propose a mutual exchange of photos. If the user viewing the profile wishes to send the message, the cursor 804 is moved to the icon and the mouse is clicked. In the preferred embodiment, the website records the user's willingness to a mutual exchange at the same time that the automated message is sent, eliminating the need for the user to initiate a separate message to the website.

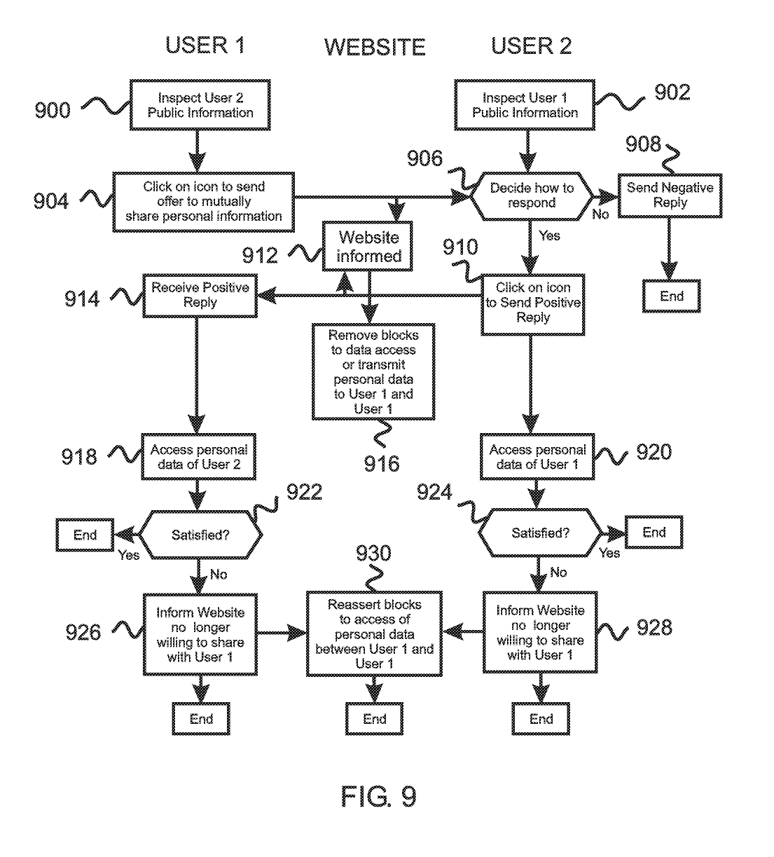

FIG. 9 presents a block diagram illustrating an embodiment of the method whereby the initial offer to share mutual information 904 and the response 906 are initiated by the users clicking on icons provided by the website. In both cases, standard, automated messages are transmitted, and the website is automatically informed 912 of the willingness of each user to share sensitive personal information with the other user, eliminating the need for the separate steps of informing the website included in 714 and 716 of FIG. 7.

Other modifications and implementations will occur to those skilled in the art without departing from the spirit and the scope of the invention as claimed. Accordingly, the above description is not intended to limit the invention except as indicated in the following claims.

What is claimed is:

1. A method for exchanging sensitive personal information between a first user and a second user of an online introductory meeting website, each user having a publicly viewable profile stored on the website, each user having sensitive personal information that is not publically viewable on the website, the method comprising:
the first user accessing the profile of the second user, without being able to access the sensitive personal information of the second user, and the second user accessing the profile of the first user, without being able to access the sensitive personal information of the first user;
the first user sending a first message to the second user requesting sensitive personal information pertaining to the second user, in exchange for providing to the second user corresponding sensitive personal information pertaining to the first user;
the second user sending a second message to the first user indicating a response to the first message, agreeing to provide to the first user the requested sensitive personal information if the response is positive, and not agreeing to provide to the first user the sensitive personal information if the response is negative;
the first user and the second user both informing the website of their willingness to mutually share sensitive personal information if the response of the second user was positive, and the first user and the second user taking no action if the response was negative;
each of the first user and the second user providing the requested personal information to the website if it is not already stored on the website; and
the website providing the sensitive personal information of the first user to the second user, and the website also providing the sensitive personal information of the second user to the first user, if information is received from both the first user and the second user indicating that each has agreed to a mutual exchange of sensitive personal information with the other, and no action being taken by the website if such information is not received from at least one of the first user and the second user.

2. The method of claim 1, wherein the sensitive personal information includes at least one of:
a photograph;
feedback from an in-person encounter
a telephone number;
an email address;
an instant messaging address
a mailing address;
a recording of the user's voice; and
other identifying contact details.

3. The method of claim 1, wherein the online introductory meeting website is at least one of:
a dating website;
a friendship website;
a roommate matching website;
a hobby and mutual interest website;
a seller-to-buyer sales website;
a landlord-tenant matching website; and
a business networking website.

4. The method of claim 1, wherein the first user sending a first message to the second user includes:
sending the first message within the online dating website.

5. The method of claim 1, wherein the first user sending a first message to the second user includes:
sending the first message via email.

6. The method of claim 4, wherein the first message is sent by the first user clicking on an icon.

7. The method of claim 6, wherein clicking on the icon results in adding the profile to a sensitive personal information exchange list.

8. The method of claim 1, wherein if the response is positive, the first user provides the second user with access to the sensitive personal information of the first user at the same time that the second user provides the first user with access to the sensitive personal information of the second user.

9. The method of claim 1, wherein the sensitive personal information of the first user and the sensitive personal information of the second user are both stored on a server that hosts the website.

10. A method for exchanging sensitive personal information between a first user and a second user of an online dating website, the method comprising:
each user storing a profile on a server that hosts the website, each profile including sensitive personal information;
providing the first user with access to the sensitive personal information of the second user, and providing the second user with access to the sensitive personal information of the first user, only if both the first user and the second user have informed the website of a willingness to mutually exchange sensitive personal information.

11. The method of claim 10, wherein the sensitive personal information includes at least one of:
a photograph;
feedback from an in-person encounter
a telephone number;
an email address;
an instant messaging address
a mailing address;
a recording of the user's voice; and
other identifying contact details.

12. The method of claim 10, wherein the sensitive personal information is a telephone number.

13. The method of claim 10, providing the first user with access to the sensitive personal information of the second user, and simultaneously providing the second user with access to the sensitive personal information of the first user.

14. The method of claim 10, wherein sensitive personal information is stored on the server as part of a record in a data table.

15. The method of claim 14, wherein the record in the data table also includes a data status field that encodes information regarding access properties of the record, and consequently of the personal information stored therein.

16. The method of claim 10, wherein when both the first user and the second user have informed each other of a willingness to mutually exchange sensitive personal information, both the first user and the second user add each other to a sensitive personal information exchange list.

17. The method of claim 16, wherein the sensitive personal information exchange list is checked by the server before allowing access to sensitive personal information.

18. The method of claim 16, wherein access to sensitive personal information can be blocked by either the first user or the second user removing the other from the sensitive personal information exchange list.

19. The method of claim 10, wherein a user informs another user via an instant message system of a willingness to mutually exchange sensitive personal information.

20. A method for exchanging sensitive personal information between a first user and a second user of an online dating website, each user having a profile stored on the website, each profile including sensitive personal information, each user initially having access to each other's profile, but not each other's sensitive personal information, the method comprising:
the first user gaining access to the sensitive personal information of the second user, and the second user gaining access to the sensitive personal information of the first user, only after both the first user and the second user have informed each other of a willingness to mutually grant access to sensitive personal information.

21. The method of claim 20, wherein the first and second users gain access to each others sensitive personal information simultaneously.

22. The method of claim 20, wherein when both the first user and the second user have informed each other of a willingness to mutually grant access to sensitive personal information, both the first user and the second user are allowed access to the sensitive personal information resident on the server that hosts the online dating web site.

23. The method of claim 20, wherein if either the first user or the second user indicates an unwillingness to grant access to sensitive personal information, such access is blocked.

24. The method of claim 20, wherein the second user is informed of a willingness of the first user to mutually grant access to sensitive personal information via a server that hosts the online dating website.

25. The method of claim 20, wherein host server informs the first user and the second user of a willingness to mutually grant access to sensitive personal information by sending respective emails.

26. The method of claim 20, wherein host server informs the first user and the second user of a willingness to mutually grant access to sensitive personal information by posting respective account messages.

27. The method of claim 20, wherein the host server informs the first user and the second user of a willingness to mutually grant access to sensitive personal information by simultaneously posting respective account messages, and also simultaneously removing a block that prevents the first user from accessing the sensitive personal information of the second user, and prevents the second user from accessing the sensitive personal information of the first user.

28. The method of claim 20, wherein host server informs the first user and the second user of a willingness to mutually grant access to sensitive personal information by simultaneously posting respective account messages, and also by simultaneously sending via email the sensitive personal information of the second user to the first user, and sending via email the sensitive personal information of the first user to the second user.

29. The method of claim 20, wherein the sensitive personal information includes at least one of:
a photograph;
feedback from an in-person encounter
a telephone number;
an email address;
an instant messaging address
a mailing address;
a recording of the user's voice; and
other identifying contact details.

30. A method for exchanging a personal photograph between a first user and a second user of an online dating website, each user having a profile stored on the website, each profile including a personal photograph, the method comprising:
the first user accessing the profile of the second user, without being able to access the personal photograph of the second user, and the second user accessing the profile of the first user, without being able to access the personal photograph of the first user;
the first user sending a first message to the second user requesting access to the personal photograph of the second user, in exchange for granting permission for the second user to access the personal photograph of the first user;
the second user sending a second message to the first user indicating a response to the first message, agreeing to provide the first user with access to the personal photograph of the second user if the response is positive, and not agreeing to provide the first user access to the personal photograph of the second user if the response is negative;
the first user and the second user both informing the website of their willingness to mutually share sensitive personal photographs if the response of the second user was positive, and the first user and the second user taking no action if the response was negative; and
the website providing the personal photograph of the first user to the second user, and the website also providing the personal photograph of the second user to the first user, if information is received from both the first user and the second user indicating that each has agreed to a mutual exchange of personal photographs with the other, and no action being taken by the website if such information is not received from at least one of the first user and the second user.

31. The method of claim 30, wherein the first message is sent by the first user by clicking on an icon, whereupon a message is sent to the second user indicating a photo exchange is desired, and whereupon the profile of the second user is placed on the photo swap list of the first user.

32. The method of claim 30, wherein the second message is sent by the second user by clicking on an icon, whereupon a message is sent to the first user indicating a photo exchange is desired, and whereupon the profile of the first user is placed on the photo swap list of the second user.

33. The method of claim 31, wherein the first message is sent from the first user to the second user within the dating website.

34. The method of claim 32, wherein the second message is sent from the second user to the first user within the dating website.

35. The method of claim 30, wherein the first message is sent by the first user by clicking on an icon, whereupon the profile of the second user is placed on the photo swap list of the first user, and wherein the second message is sent by the second user by clicking on an icon, wherein whereupon the profile of the first user is placed on the photo swap list of the second user; and
the personal photograph of the first user is made available to the second user while the personal photograph of the second user is made available to the first user.

36. The method of claim 35, wherein the personal photograph of the first user is made available to the second user by sending the personal photograph of the first user to the second user, while the personal photograph of the second user is made available to the first user by sending the personal photograph of the second user to the first user.

37. The method of claim 35, wherein the personal photograph of the first user is made available to the second user by removing a block preventing the second user from viewing the personal photograph of the first user, while the personal photograph of the second user is made available to the first user by removing a block preventing the first user from viewing the personal photograph of the second user.
